(19) United States
(12) Patent Application Publication
(10) Pub. No.: US 2024/0353592 A1
(43) Pub. Date: Oct. 24, 2024

(54) Chalcogenide Hybrid Inorganic/Organic Polymers for Near Infrared Optics and Their Applications

(71) Applicant: Norcon Technologies Holding, Inc., Tucson, AZ (US)

(72) Inventors: Jay Liebowitz, Cambridge, MA (US); Robert A. Norwood, Tucson, AZ (US); Kyung-Jo Kim, Tucson, AZ (US); Sasaan Showghi, Tucson, AZ (US)

(21) Appl. No.: 18/288,950

(22) PCT Filed: Apr. 28, 2022
(86) PCT No.: PCT/US22/26622

§ 371 Date: Oct. 30, 2023

Related U.S. Application Data
(60) Provisional application No. 63/182,102, filed on Apr. 30, 2021.
(60) Provisional application No. 63/182,573, filed on Apr. 30, 2021.
(60) Provisional application No. 63/182,627, filed on Apr. 30, 2021.

(51) Int. Cl. G02B 1/04; C08G 75/045

(52) U.S. Cl. CPC G02B 1/041; C08G 75/045

(57) ABSTRACT

A method of using S-NBD2 for application in a infrared spectrum is provided. The method includes the steps of providing S-NBD2; forming the S-NBD2 into an optical device; and using the optical device in the near infrared spectrum.

### STATEMENT REGARDING FEDERALLY SPONSORED RESEARCH OR DEVELOPMENT

This invention was made with government support under SBIR Contract No. 2016089 awarded Sep. 1, 2020. The government has certain rights in the invention.

### BACKGROUND OF THE INVENTION

### Field of the Invention

The present invention uses chalcogenide hybrid inorganic/organic polymers (“CHIPS” or organic chalcogenide polymers) for near infrared (NIR) optical applications. This patent application identifies the significance of the thermal expansion properties, high refractive index, and low optical absorption of CHIPS in NIR applications versus current optical polymers that are transmissive in the NIR in relation to the design and construction of optical assemblies consisting of one or more lenses. In this application, the NIR is defined as 700 to 1600 nm wavelength.

### Description of the Related Art

CHIPs were developed as a polymer version of chalcogenide glass, which was in turn developed to be a low cost, more processible and more rugged version of infrared optical materials such as germanium, II-VI compounds such as zinc sulfide and zinc selenide, and infrared transparent salts such as potassium bromide and calcium fluoride. The original patent for CHIPS, U.S. Pat. No. 9,306,218, recognizes the use of the material for infrared applications in its discussion of high refractive indices, between 1.7 and 2.2 from 300 nm to 1500 nm wavelength, transmittance, and lenses. That patent does not define optical transparency or absorption. The material covered by the original patent has a glass transition temperature of just 55° C., which is not generally useful in applications outside of a research laboratory.

It would be beneficial to provide a material to relieve the difficulties imposed by the current inorganic materials, particularly with respect to cost and processing difficulties.

Additionally, high index glass optics are used in imaging and sensing applications as singlet lenses, according to the lens maker equation of 1/f=(n−1)/R, where f is the focal length, n is the refractive index (“index”) of the optical medium, and R is the radius of curvature of the lens, so as to increase R, shorten f, increase numerical aperture, or decrease f/# and shutter speed. In doublets and more complicated lens assemblies, high index glass lenses are used with a lower index glass lens for reducing chromatic aberrations; such doublets are known as achromats. Low index refers to the range between 1.45 and 1.6, while high index refers to the range from 1.7 to 1.9. In general, these glass lenses, whether high or low index, have values of internal transmittance of at least 99.9% per mm, coefficients of thermal expansion below 10 ppm/° C., and thermo-optic coefficients (dn/dT) below 5 ppm/° C. The most common optical-grade glass is the low index borosilicate glass N-BK 7, with an index of 1.51; a common high index glass is the lanthanum crown glass N-LAK10, with an index of 1.71, as well as lanthanum flint glass N-LASF9, having an index of 1.83 (indices at 940 nm).

At times, lenses made from optical polymers can be used as alternatives to lenses made of N-BK-7 and other low index glasses. The substitution can be made in benign environments when transmittance requirements are reduced and optothermal requirements are less stringent. NIR optical polymers exhibit lower internal transmittance, being generally above 90% for 1 mm thickness. They have refractive indices that span from 1.48, for PMMA (polymethylmethacrylic) to 1.57 for polycarbonate (some polymers have indices above 1.6, but typically do not have adequate transmittance in the NIR and are confined to micro-optic applications). There has not been an optical polymer that has exhibited an index above 1.7 and has internal transmittance above 90% for 1 mm of thickness. Typical optical polymers have CTE values above 65 ppm/° C. and dn/dT values in the 80 to 130 ppm/° C. range.

Optical designers, nevertheless, use polymer lenses when they need to adopt complex lens shapes, reduce weight, or lower cost. Polymers can be molded at temperatures below 200° C. into freeform optics, whereas glasses are molded at temperatures well above their glass transition temperatures, which are above 500° C. These elevated temperatures make shape forming difficult and increase costs considerably versus polymer lenses. Polymer lenses of the same dimensions as glass lenses are 50% lighter because the densities of polymers are generally in the 1.2 g/cc range, whereas glasses are in the 2.5 g/cc range. The absence of an optical polymer with adequate optical performance and sufficiently high index has kept optical polymers from being used as an alternative to high index glasses.

It would be beneficial to provide an optical polymer with a high index to replace high index glasses.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, the present invention is a method of using S-NBD2 for application in a infrared spectrum is provided. The method includes the steps of providing S-NBD2; forming the S-NBD2 into an optical device; and using the optical device in the near infrared spectrum.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 shows an exemplary polymer chain of S₅₀-NBD2₅₀;

FIG. 2 shows the coefficient of thermal expansion (CTE) for S₅₀-NBD2₅₀ compared to other optical polymers;

FIG. 3 is a graph showing the refractive index, measured by prism coupling ellipsometry, of S₅₀-NBD2₅₀;

FIG. 4 is a graph comparing the refractive index of S₅₀-NBD2₅₀ with S₇₀-NBD2₃₀; and

FIG. 5 is a graph of Absorption limited transmission spectrum in transmittance vs. wavelength for absorption limited transmission and transmission with a single layer AR coating for 1550 nm.

### DETAILED DESCRIPTION

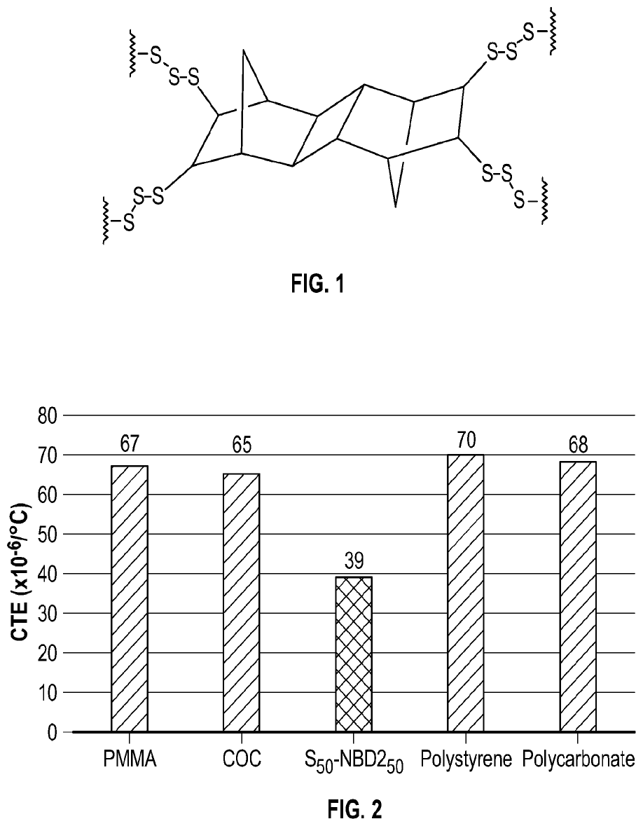

In the drawings, like numerals indicate like elements throughout. Certain terminology is used herein for convenience only and is not to be taken as a limitation on the present invention. The terminology includes the words specifically mentioned, derivatives thereof and words of similar import. In this application, the near infrared (“NIR”) is defined as 700 to 1600 nm wavelength. Also, the “50” in the formula S₅₀-NBD2₅₀ is the weight percentage of sulfur and NBD2 in that polymer chain. Similarly, the “70” and the “30” in S₇₀-NBD2₃₀ is the weight percentage of sulfur and NBD2 in that polymer chain, respectively. In the polymer chain S₅₀-NBD2₅₀, NBD2 is a dimer of norbornadiene. Sulfur atoms are linked to NBD2 polymers in a chain similar to the chain shown in FIG. 1.

The embodiments illustrated below are not intended to be exhaustive or to limit the invention to the precise form disclosed. These embodiments are chosen and described to best explain the principle of the invention and its application and practical use and to enable others skilled in the art to best utilize the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

The word “about” is used herein to include a value of +/−10 percent of the numerical value modified by the word “about” and the word “generally” is used herein to mean “without regard to particulars or exceptions.”

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

A new formulation of CHIPs was developed to address the limitations of first generation CHIPs materials that have neither the desired IR transparency properties nor thermomechanical properties for use in a suitable IR imaging system.

Methods for using a version of organic chalcogenide polymer that is useful principally, in the 700 nm to 1600 nm wavelength region are provided. Characterization of S-NBD2, which has the properties of a thermoset polymer, for optical, material, and chemical properties for use in this wavelength region has been performed. S-NBD2 is determined to be stable optically with a T_{g} at least 85° C.

### Example

Measurements of both S₇₀-NBD2₃₀ and S₅₀-NBD2₅₀ have demonstrated an internal transmittance of no higher than 85% for a thickness of 1 mm from 800 to 1600 nm wavelength, especially at the critical wavelengths of 940 nm and 1550 nm. For this same material, an increase in absorption starting at 1200 nm wavelength and dropping to 450 nm wavelength that follows a 1/λ² Mie scattering law has been observed. For broad commercial use, however, the internal absorption must be less than or equal to 0.05 cm⁻¹ in this wavelength range. Just as critically, Mie scatter is not acceptable because the radiation from an object being imaged will suffer from excessive distortion at the focal plane. Instead, the decay should ideally follow a 1/λ⁴ Rayleigh scattering behavior, but definitely no worse than 1/λ³. These values are especially critical when the optical material is used in active imaging applications in which S-NBD2 can be used, whereby a target is illuminated by a laser, typically at a wavelength of 850, 905, 940, 1060, 1064, 1310, 1400, 1535, or 1550 nm, and the reflected radiation is imaged onto a single-pixel or multi-pixel focal plane array photodetector, in which S-NBD2 can also be used. Increase in optical absorption by the optical material decreases detection and imaging range, while scattering increases positioning error and degrades image quality.

S-NDB2 is used to relieve the limitations of other CHIPs that do not have the desired IR transparency properties or thermomechanical properties for incorporation into an IR imaging system. The following properties of S-NDB2 were measured and are critical for the use of S-NDB2 in the near infrared wavelength region.

### Coefficient of Thermal Expansion

A critical mechanical property required for optical design is the coefficient of thermal expansion (“CTE”). The CTE of S₅₀NBD2₅₀ was measured both by an in-house interferometric method and by a third party using the recommended ASTM E831-19 method. Both methods agreed to within 5%, with the ASTM E831-19 method giving a value of 39×10⁻⁶/° C. which is significantly less than that of typical optical polymers, as shown in FIG. 2; this is a definite benefit of the use of S₅₀NBD2₅₀ in near infrared applications, with S₅₀NBD2₅₀ having a CTE in a range between about 30×10⁻⁶/° C. and about 50×10⁻⁶/° C. In terms of thermo-mechanical properties, it was further established that the glass transition temperature is ˜ 105° C., and that an approximate use temperature of 85° C. is viable, based on the thermoset nature of the polymer and extensive cycling measurements (100 cycles from −45° C. to 85° C.) indicating no observable change in transmission.

The 39×10⁻⁶/° C. CTE (or at least 50×10⁻⁶/° C.) of S₅₀-NBD2₅₀ is significant in two ways. First, lenses are often mechanically held in place by metal housings. The temperature range over which the optical assembly can be used depends, in part, on the closeness of CTE of the optical material and the metal. If the match is too far apart, after a sufficient number of cycles over the temperature range, the joint between the metal and the lens weakens. The lens then does not stay in place properly, resulting in a degradation in focusing and image quality. By way of example only, the CTE of aluminum, a common assembly material, is 23 ppm/° C., the CTE for N-BK 7 glass, the most common optical grade class is 7 ppm/° C., and the CTE of the most common stainless steel, 304, is 17 ppm/° C. For applications where aluminum is desired, the difference between aluminum and glass is, in absolute value, the same as between aluminum and S₅₀-NBD2₅₀, just as the ratio between aluminum and S₅₀-NBD2₅₀ is +70%, while the ratio between aluminum and glass is-70%. The similar values and ratios make the use of S₅₀-NBD2₅₀ lenses a viable alternative, whereas conventional optical polymers, as shown in FIG. 2, are not.

Second, the CTE provides a measure of the shift of the focal position of a lens in an optical design over a given temperature range. As can be seen in FIG. 2, the CTE of S₅₀-NBD2₅₀ is at least 40% lower than the CTE values for the other optical polymers. The effect of this lower CTE means that the focal point shifts proportionally less, or, for the same shift tolerated, the temperature can vary by as much as 1/(1−0.40), or 67%, more. If, for example, an optical system using lenses that have a CTE of about 68×10⁻⁶/° C. is replaced with lenses that have a CTE of 39×10⁻⁶/° C., the temperature range of ±20° C. can be increased to ±35° C. This increase in temperature range is particularly valuable in smartphones that use NIR 3D sensing as part of their autofocus mechanism for visible spectrum 2D imagery. The performance of 3D depth perception using lower CTE S-NBD2 lenses provides more accurate depth determination, resulting in sharper visible 2D imagery over a wider temperature range than was possible with lenses made of optical polymers with higher values of CTE. The increase in temperature range is also of value in range finding devices, where the more collimated the laser beam, the more the distance range of the finding device is increased. This increase in distance range can be understood by observing that a shift in focal length of a lens can cause the laser beam to become more diffuse over distance. When a beam diverges too much, too few photons reach the target, so that the return is too weak for the range finding device's photodetector to collect and measure. A decrease in CTE keeps the beam more collimated over a wider temperature range, enabling the use of the range finding device over longer distances for a given temperature range.

These are novel uses of the lower CTE of lenses made of optical polymers. Until the CTE of S₅₀-NBD2₅₀ was measured, there had been no anticipation by those skilled in the art concerning the potential for a CTE of an optical material lying between glass and conventional polymers that matches thermally so well with aluminum (Al). There also has not been anticipation of polymer lenses that increase the temperature range for measuring depth accurately.

The CTE of S₅₀-NBD2₅₀ is not as low as the <10 ppm/° C. of high index glasses, but it is important to note that for applications that use housings made of Al, the CTE match between S-NBD2 and Al (CTE=23 ppm/° C.), is viewed by optical engineers as comparable, if not superior, to the CTE match between glass and Al. Moreover, Al is often used instead of steel as a means to save weight, so the lower density of S-NBD2 versus glass is also advantageous.

### Refractive Index

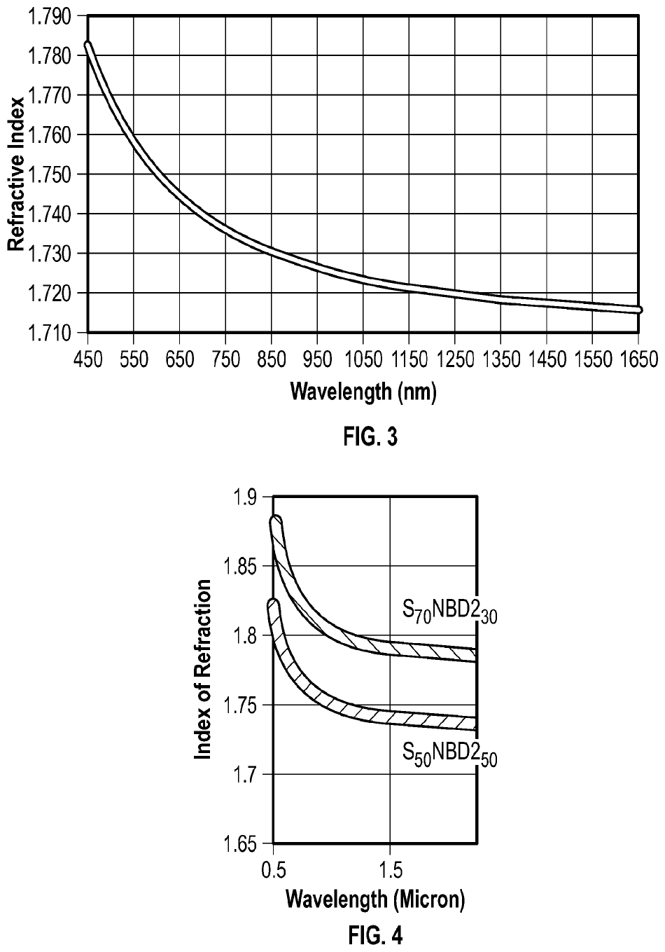

A additional critical property of S₅₀-NBD2₅₀ that makes S₅₀-NBD2₅₀ especially useful in the near infrared spectrum is its refractive index. The refractive index of S₅₀-NBD2₅₀ across the near infrared spectrum is shown in FIG. 3 and a comparison of the refractive index of S₅₀-NBD2₅₀ compared to S₇₀-NBD2₃₀ is shown in FIG. 4. When light is incident on an optical material sample of thickness L, and refractive index n, the light will generally experience a variety of physical phenomena in traversing the sample, namely reflection, scattering and absorption. Both surface and bulk optical scattering are taken to be negligible, which can be achieved when optical components are made with state-of-the-art processes.

S-NBD2 lenses that meet the scattering requirements for optical polymers can be used in the inventive method. Moreover, S-NBD2 provides an optical polymer alternative to the high index glass lenses now in use. The index of S₅₀-NBD2₅₀ is 1.73 at 850 nm wavelength and 1.72 at 1250 nm wavelength, and remains greater than 1.7 and less than 1.9 throughout the near infrared spectrum, as shown in FIG. 3. The index of the 70% sulfur by weight S₇₀-NBD2₃₀ is 1.77 at 940 nm wavelength and 1.76 at 1550 nm wavelength.

### Absorption

For near infrared light having wavelength A and directed normally incident on the sample, the optical properties of the material can be characterized through the wavelength dependent refractive index n(λ) and absorption coefficient α(λ). Fresnel reflection will occur at the incident interface, with the fraction of the incident power reflected by the interface being given by the reflectance, R,

$$R = ( ( n ( λ ) - 1 ) / ( n ( λ ) + 1 ) ) \hat{} 2 \qquad Equation 1$$

where the absorption coefficient is taken to be very small such that it has negligible contribution to the reflection. Fresnel reflection will occur at both the input and output interfaces, which then provides a factor of (1−R)² to the transmittance, T, which has a maximum value of 1. For example, for typical optical glass with a refractive index of 1.5, R=0.04, so the transmittance of a piece of glass with negligible absorption is given by T_{F}=(0.96)²×1=0.92, where the subscript F is used to indicate that this is the transmittance expected for Fresnel reflection of normally incident light at both interfaces.

When absorption is not negligible, the transmittance will be further reduced by a factor given by e\hat{ }(−α(λ)L); this is known as Beer's law. The total transmittance, Tₜ is then given by

$${T}_{t} = ( 1 - R ) \hat{} 2 e \hat{} ( - a ( λ ) L ) \qquad Equation 2$$

This total transmittance can be called the absorption limited transmittance, since all scattering contributions have been taken to be zero; this is the highest transmittance that can be achieved in a material with absorption coefficient α(λ) for a sample of length L.

For conventional optical polymers the absorption limited transmittance in the near infrared region between 800 nm and 2000 nm is determined by the absorption contribution from molecular vibrational overtones of carbon-hydrogen, oxygen-hydrogen, and carbon-carbon. In particular, at the prevalent application wavelength of 1550 nm, optical polymers such as PMMA and polycarbonate have absorption coefficients of about 0.1-0.2 cm⁻¹. The spectral position of molecular vibrational overtones is related to the mass of the atoms involved in the vibration; a simple mass-spring model of a molecular vibration involving two atoms predicts that the frequency of a molecular vibration is inversely proportional to the square root of the reduced mass of the two atoms. Thus, vibrations involving light atoms like hydrogen have high frequencies (short wavelengths), leading to the absorption coefficients quoted above. A key advantage of the chalcogenide hybrid inorganic/organic polymers, in addition to their high refractive indices and low coefficients of thermal expansion, is their large fraction of sulfur bonds. Since the sulfur atom is heavy (atomic weight of 32) compared to carbon (12) and especially hydrogen (1), the vibrational frequencies of sulfur-sulfur bonds are very low, corresponding to wavelengths greater than 10 microns, leading to negligible absorption in the near infrared. This means that for a typical chalcogenide polymer with 50% by weight sulfur, the absorption coefficient at 1550 nm is a factor of two or more below that of typical optical polymers, on the order of 0.05 cm⁻¹, providing increased flexibility in optical design and manufacture.

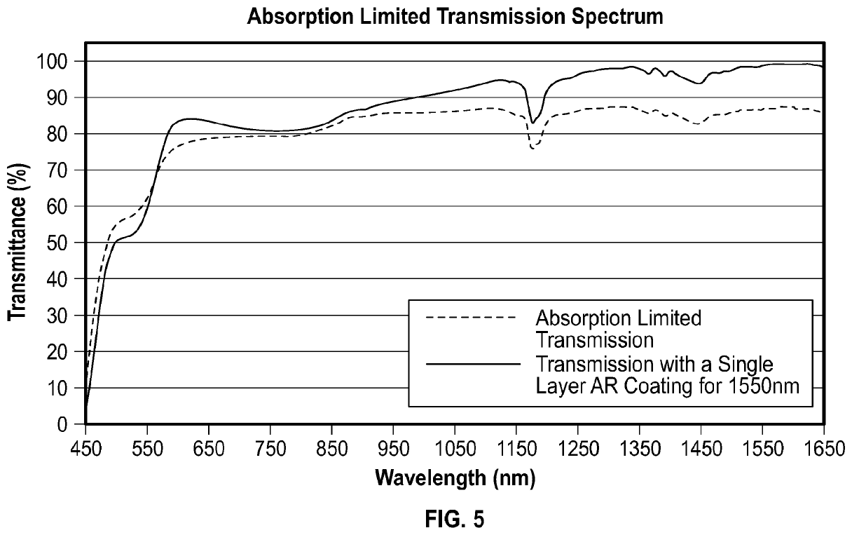

FIG. 5 is a graph showing the absorption limited transmission spectrum of S₅₀NBD2₅₀. The theoretical transmission is plotted vs. wavelength for a planar window geometry with a thickness of 1.4 millimeters (a typical thickness required for the target near infrared applications). By way of example only, the maximum transmission at 1550 nm is approximately 86%, where practically all of the reduction in transmission (below 100%) is caused by Fresnel reflection at the interfaces and not by absorption. FIG. 5 also shows the theoretical transmission of the same window with an ideal anti-reflection coating for 1550 nm deposited on both sides; the transmission now rises to close to 99%.

Benefits of the use of S-NBD2 in near infrared spectrum applications include:

Use as an optical polymer alternative to high index glass lenses;

Use as an optical polymer in a metrology device;

Use as an optical polymer in a spectroscopy device;

Use as a discrete element such as a spherical or aspherical lens, a freeform optic or an integrated lens assembly, a light pipe, compound parabolic concentrator, or other optical design obvious to those practiced in the art;

Use in making S-NBD2 optics, either discrete or integrated, for achieving benefits similar to those realized with high index glass optics, such as shortening the focal length, reducing the size and weight of the lens housing, reducing the material consumption that derives as a benefit from the higher index, decreasing shutter speed, widening field-of-view, increasing detection range, and other benefits that are obvious to those practiced in the art;

Replacement of a costly single element glass asphere with a lower total cost pair of spherical polymer lenses;

Integration of multiple, discrete glass lenses into a single integrated lens assembly that reduces the size, weight, or cost of the original lens;

Reduction in the mass and size of a glass lens assembly by replacement with a polymer integrated lens assembly such that the mass and size reduce the moment of inertia, resulting in improved ergonomics, increased styling options, faster rotational speeds, and other benefits obvious to someone skilled in the art;

Lighter weight optical lens assemblies that enable unmanned aerial vehicles, a.k.a. drones, to be airborne and operational for longer durations based on reduced drain on its battery.

It will be further understood that various changes in the details, materials, and arrangements of the parts which have been described and illustrated in order to explain the nature of this invention may be made by those skilled in the art without departing from the scope of the invention as expressed in the following claims.

We claim:

1. A method of using S-NBD2 for application in a near infrared spectrum, the method comprising the steps of:
(a) providing S-NBD2;
(b) forming the S-NBD2 into an optical device; and
(c) using the optical device in the near infrared spectrum.

2. The method according to claim 1, wherein step (a) comprises providing S-NBD2 having the following properties:
(1) a coefficient of thermal expansion of less than 50×10⁻⁶/° C.;
(2) a refractive index above 1.7 in the near infrared spectrum; and
(3) an absorption coefficient, wherein, across the near infrared spectrum, the absorption coefficient is less than or equal to 0.05 cm⁻¹.

3. The method according to claim 2, wherein step (a) comprises providing the S-NBD2 having a T_{g} at least 85° C.

4. The method according to claim 2, wherein step (a) comprises providing the S-NBD2 having the refractive index less than 1.9 in the near infrared spectrum.

5. The method according to claim 2, wherein step (a) comprises providing the S-NBD2 having the coefficient of thermal expansion between 30×10⁻⁶/° C. 30 and 50×10⁻⁶/° C.

6. The method according to claim 1, wherein providing S-NBD in step (a) comprises providing S₅₀-NBD2₅₀.

7. The method according to claim 1, wherein step (c) comprises using the S-NBD2 in an optical lens.

8. The method according to claim 7, further comprising installing the lens in an aluminum frame.

9. The method according to claim 1, wherein step (c) comprises using the S-NBD2 in a range finding device.

10. The method according to claim 9, wherein using the range finding device comprises using one of single-pixel and focal plane array multi-pixel photodetectors.

11. The method according to claim 1, wherein step (c) comprises using the S-NBD2 in an active imaging device.

12. The method according to claim 1, wherein step (c) comprises using the S-NBD2 to produce two-dimensional renderings as images or as depth perception maps of real-world 3D scenes.

13. The method according to claim 1, wherein step (c) comprises using the S-NBD2 in a metrology device.

14. The method according to claim 1, wherein step (c) comprises using the S-NBD2 in a spectroscopy device.

15. A method of using an optical polymer for application in a near infrared spectrum, the method comprising the steps of:
(a) providing the optical polymer having the following properties:
(1) a coefficient of thermal expansion of less than 50×10⁻⁶/° C.;
(2) a refractive index above 1.7 in the near infrared spectrum; and
(3) an absorption coefficient, wherein, across the near infrared spectrum, the absorption coefficient is less than or equal to 0.05 cm⁻¹;
(d) forming the polymer into an optical device; and
(e) using the optical device in the near infrared wavelength spectrum.
